(19) United States
(12) Patent Application Publication
(10) Pub. No.: US 2013/0253941 A1
(43) Pub. Date: Sep. 26, 2013

(54) METHOD FOR SCHEDULING MEDICAL FACILITIES

(71) Applicant: Mark E. Stickler, Annapolis, MD (US)

(72) Inventor: Mark E. Stickler, Annapolis, MD (US)

(73) Assignee: Stickler Holdings, LLC, Annapolis, MD (US)

(21) Appl. No.: 13/426,034

(22) Filed: Mar. 21, 2012

(51) Int. Cl. G06Q 50/22

(52) U.S. Cl. 705/2

(57) ABSTRACT

The invention is a medical procedure case scheduling system which provides real time communication between varying departments of a hospital and healthcare facilities vendors. A surgical case or procedure is posted on the system in a particular color. After posting, all associated parties from the hospital staff and the vendors can visually see the case along with the specific case details once they are logged into the system. The vendors have the ability to acknowledge and verify the case and supply case specific equipment and accessories lists back to the facility. Once the case has been verified, the display changes to a different color so that all parties can visually see the verification process. When the vendor's equipment and accessories are all present and the case is ready. A ready color indication is displayed on the schedule calendar.

### TECHNICAL FIELD

The present invention is related to automated data management solutions for use over data networks. More particularly, the present invention relates to automated medical case scheduling, logistics management, time management and data management. The system described herein can be used by or on behalf of healthcare providers and their vendors.

### BACKGROUND OF THE INVENTION

Miscommunication of surgical case information accounts for a large amount of surgical errors in the medical field. Healthcare facilities are becoming more frustrated with the current system in place which requires a large amount of paperwork, phone calls, and emails to coordinate one case. Surgical cases often have multiple vendors associated with a case that need to be present which causes more confusion for the healthcare facility staff to ensure that they have the right vendor, the right products and the right information for each case. Also, with the current system, there are no true checks to ensure that the necessary vendor or vendors are aware of a case. For example, with the current system, a hospital scheduler fills out case scheduling paperwork for a vendor to sign off on. If the vendor has not been to the hospital in a while, the scheduler must call (leaving a message) or email one or more vendors about a case. Often those calls/emails go without a response causing that particular hospital employee to follow up a second and third time. The current system also causes unnecessary personnel such as outside vendors to be in or near the operating room where there is direct access to patients, patient information, other healthcare staff members and potentially infectious diseases.

As the healthcare industry grows with the patient population, the medical facilities such as hospitals are doing on average 750-1200 surgical cases a month, a number which continues to grow. This increases the demands and workloads of the healthcare facility staff to try and ensure that the right information is being provided to the right people in a timely manner. This increase in the industry causes more and more miscommunication which delays surgical cases or causes them to be cancelled, unnecessarily inconveniencing patients, doctors, healthcare staff members, and vendors. The miscommunication also stems from the amount of people involved in the communication process. Just one case can cause up to 20 different phone calls or emails back and forth between hospitals schedulers, operating room coordinators, sterile processing personnel, doctor's offices and vendors. With the average facility handling on the order of 900 cases, this can lead to 15,000 or more phone calls or emails in one month, often with specific patient identifiable information used in an unsecure manner.

The increasing number of surgical cases at every healthcare facility across the country is causes numerous challenges for the industry to keep up. This affects not only the healthcare facility's staff members, but also medical companies, vendor reps, medical delivery personnel, and doctors, among others. Miscommunication and the inability of the supply of necessary instruments, implants, and accessories to keep up with the increase in patient demand often requires overnight delivery of supplies, unnecessarily increasing costs. If the necessary equipment is not available for the facility to use, doctors are forced to reschedule a case or potentially use a product or device that they are not as familiar with. Vendors such as medical companies have been able to sterilize late arriving equipment in an autoclave but this is extremely unfavorable for the patient. This sterilization method is so unfavorable that a Joint Commission, often referred to as JACO, requires healthcare facilities to reduce such sterilizations to zero except in the case of extreme emergencies. The industry is being pressed even more to have timely service which increases the need for real-time detailed communication.

Outside influences come into play as a result of communication and clerical errors. If a hospital staff member goes away on vacation, maternity leave, moves, or is otherwise not able to work, there is no universal system in place that allows a new person to know where the other person has left off in the scheduling process. For example, suppose a hospital scheduler who is responsible for contacting the vendors and scheduling specific cases calls off of work. The new vendor scheduler must spend countless hours trying to figure out where the other scheduler left off and try to figure out if all of the vendors are aware of specific surgical cases. The new vendor scheduler often just writes down on a piece of paper who they tried to contact. When the original vendor scheduler comes back, they then have to review (often for hours) the piece of paper to try and confirm what cases have been acknowledged by the vendors.

Confusion often results from the surgical coordinator's and sterile processing department's need for accurate case specific instrumentation lists. Currently, the surgical coordinator spends hours daily contacting vendors individually by telephone or email to obtain an equipment list for upcoming cases. They use this list to confirm that they are receiving all of the right equipment and to ensure that cases will start on time (or at least not be delayed because of missing equipment.)

Missing equipment creates an enormous hospital and vendor expense. Current frustration stems from the lack of documentation of who is picking up equipment, who signed for it, and when the equipment was signed out. Sterile Processing Departments (SPD) and their staff are blamed as a whole for missing items, implants and trays which often range in cost from a few hundred dollars for a small missing item to hundreds of thousands of dollars of missing implants and accessories. If there is no system in place, both parties point fingers at each other. Hospitals claim that the vendor or driver picked up an item. Vendors or drivers claim that the hospital lost the equipment/implants.

The current medical scheduling process from a healthcare facility to a vendor is as follows. The hospital posting office receives a request from a doctor's office to schedule a case. The hospital scheduler posts the case to the hospital's internal medical software system. The scheduler prints surgical case information. A specific hospital staff member is in charge of vendor scheduling. The vendor scheduler reviews the posting sheet and confirms that the information is accurate. If it is not accurate, the vendor scheduler reviews the posting sheet with the doctor's office or main scheduling office. If it is accurate, the vendor scheduler sends notification to the vendor. The vendor scheduler waits for a response. If there is no response, the vendor scheduler resends information to the non-compliant vendor. This repeats until a response from the vendor is confirmed. The vendor scheduler then signs off on the paperwork. If the case information stays the same, then the case is set. If information changes, then the process starts over. Surgical coordinators, often referred to as team leaders, review the posted schedule usually by printing it out on paper and comparing to see that nothing has changed. The week of the case, the surgical coordinator will call or email reminders to the vendors and if needed, request an instrument list for specific cases. If no responses are received, the surgical coordinator re-sends the reminder and repeats the process as necessary. The day before the case, the surgical coordinator communicates with the sterile processing department to confirm that the equipment and implants or accessories have arrived from the vendor. If equipment is missing, then the surgical coordinator places an emergency phone call the non-compliant vendor. This step is repeated as needed. Once all equipment and vendors are accounted for, the sterile processing department then processes equipment. On the day of the case, the surgical coordinator arrives at the healthcare facility early to finish setting up a case cart with the vendor's sterilized equipment. If equipment is missing, the surgical coordinator and sterile processing department scramble to find the missing equipment or the vendor. If there is an issue in the surgical procedure that is vendor related, all healthcare facility staff members review the communication documents to figure out where the breakdown in communication happened.

Because of the number of people associated with scheduling a surgical case and the paperwork that needs to be documented, the present invention was developed to enhance the communication between all parties involved. This system eliminates the amount of paper generated for approval and confirmation of the healthcare facility scheduling process.

### SUMMARY OF THE INVENTION

According to a primary object of the present invention, an operating platform is provided that enables a healthcare facility vendor scheduler to schedule surgical procedures with third party vendors and equipment and implant or accessory providers. This feature will allow the necessary healthcare facility staff members to work in conjunction with each other with efficient and accurate information to reduce the number of mistakes due to miscommunication.

According to another object of the invention, an operating platform is provided that enables healthcare facility operating room coordinators or team leaders to view scheduled surgical cases and have access to case specific information. This will reduce the number of telephone calls to vendors and eliminate equipment list errors.

The operating platform enables a healthcare facility's sterile processing department to view scheduled surgical cases and see a case specific equipment list supplied directly from the vendor. This provides the sterile processing department with an accurate detailed equipment list from the vendor and reduces telephone calls.

The operating platform enables a vendor to acknowledge cases and submit an accurate and detailed equipment list to the specified healthcare facility in real-time. This will help eliminate late notifications, wrong equipment lists, and miscommunication.

With the present invention, healthcare facilities and vendors can create their own specific databases. This will provide the facilities and vendors with the ability to efficiently and accurately submit data back and forth.

All material and data associated with medical case scheduling such as notifications, calendar, databases, and the like can be archived in compliance with HIPAA requirements. Generic information can be extracted for use in business, demographical, socioeconomic studies and for educational purposes.

The present invention aids a healthcare surgical scheduler in providing real-time surgical case information to all necessary parties such as but not limited to surgical coordinators, sterile processing department staff members and approved vendors.

Healthcare facility vendor schedulers are provided with an online software solution that enables them to enter all necessary surgical case information. This solution provides a web-based system that enables them to input all data via a configured graphical user interface. Selecting data in a first section populates choices for selecting data in the second and third data sections and so on.

There are several benefits to the method and system according to the invention. A healthcare facility's vendor scheduler's job is streamlined to the point of cutting their work in half, freeing up time to focus on other crucial work in the operating room. Operating room coordinators, i.e. team leaders, can focus on their work and ensure that their patient's surgical procedures proceed as smoothly as possible. They do not have to devote hours of their day to speaking with vendors. Sterile processing departments can plan accordingly with staffing in accordance with the case equipment list and information that they receive back from the vendor. This will eliminate shortages in man power and allow them sufficient time to sterilize equipment and implants, ultimately increasing patient safety. Upon post case equipment pick up, they can drastically reduce missing equipment from vendors, saving the hospital hundreds of thousands of dollars a month. Vendor's time is freed from having to organize equipment lists and acknowledge cases, Unnecessary communication between the different departments is cut drastically. The automated system streamlines the entire communication process between all parties, putting everyone on the same schedule and ultimately improving operating room efficiency, patient safety, and quality control.

### BRIEF DESCRIPTION OF THE DRAWINGS

Other objects and advantages of the invention will become apparent from a study of the following specification when viewed in the light of the accompanying drawing, in which:

FIG. 1 is a block diagram an operating platform for enabling healthcare facility vendor schedulers to schedule medical procedures and provide real time indications of the scheduling progress in accordance with the invention;

FIG. 2 is a block diagram of the system architecture according to the invention;

FIG. 3 is a flow diagram illustrating the steps for scheduling a surgical case utilizing the system according to the invention;

FIGS. 4-15 illustrate electronic screenshots, respectively, illustrating pages displayed by the system architecture of FIG. 2 at various phases of the scheduling process; and

FIGS. 16-23 illustrate various displays, respectively, on a mobile device which allow the user to communicate electronically with the system architecture of FIG. 2.

### DETAILED DESCRIPTION

The system and method according to the invention facilitates scheduling surgical cases from the healthcare facility to the necessary parties utilizing graphical user interfaces accessible to approved staff members and vendors. The invention also archives data in compliance with HIPAA compliance and regulations standards.

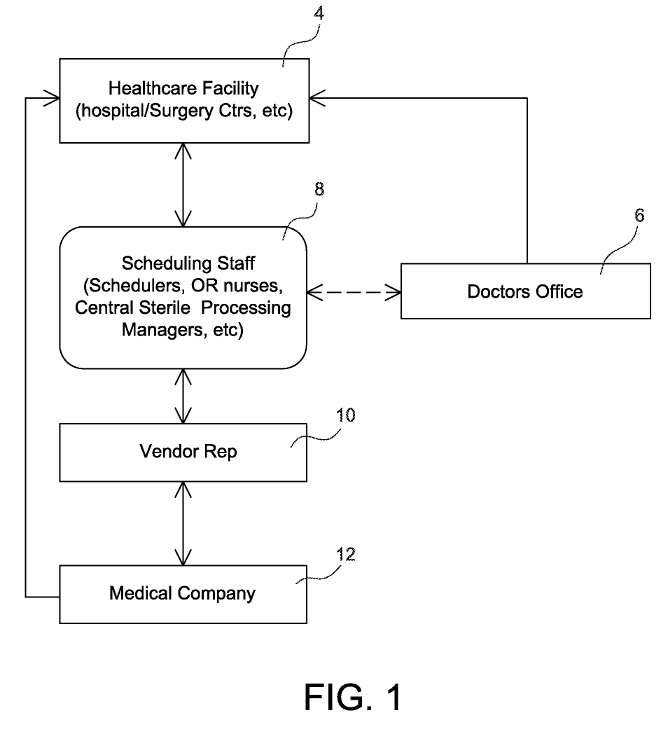

Referring first to FIG. 1, the operating system includes a secure communications network 2 that enables all crucial departments to communicate. To schedule a medical procedure, the healthcare facility 4 must first receive a request with the information for the desired procedure from the doctor's office 6. Once the information is received, personnel at the healthcare facility review the information and pass it along to the scheduling or posting department 8. The schedulers then input the information which results in a notification being sent to the vendor 10. This allows all departments participating in the procedure to be linked. These departments include the schedulers, operating room coordinators, sterile processors, and medical companies 12.

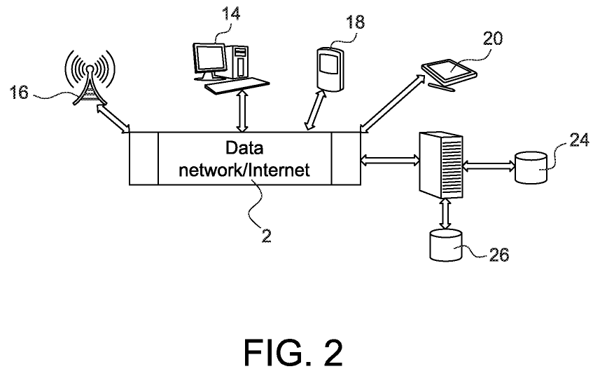

The hardware components for the system will be described with reference to FIG. 2. The system is completely Internet based and runs on a particular data network 2. Once the network is established, facilities use computer hardware 14 to run the entire system and manage their particular accounts and to schedule surgeries. When the data is transmitted to third party vendors, a cell tower 16 is needed to ensure that the data is transmitted to a mobile device such as a smart phone 18 or tablet 20 of a vendor so that the vendor can manage its accounts as well. For all of this transfer of information to be HIPPA compliant, all information is passed and stored on a dedicated server 22 that ensure that all records are encrypted and saved such as on storage disks 24. Furthermore, to ensure information back up of all the records, they are moved to an offsite database 26 for permanent storage.

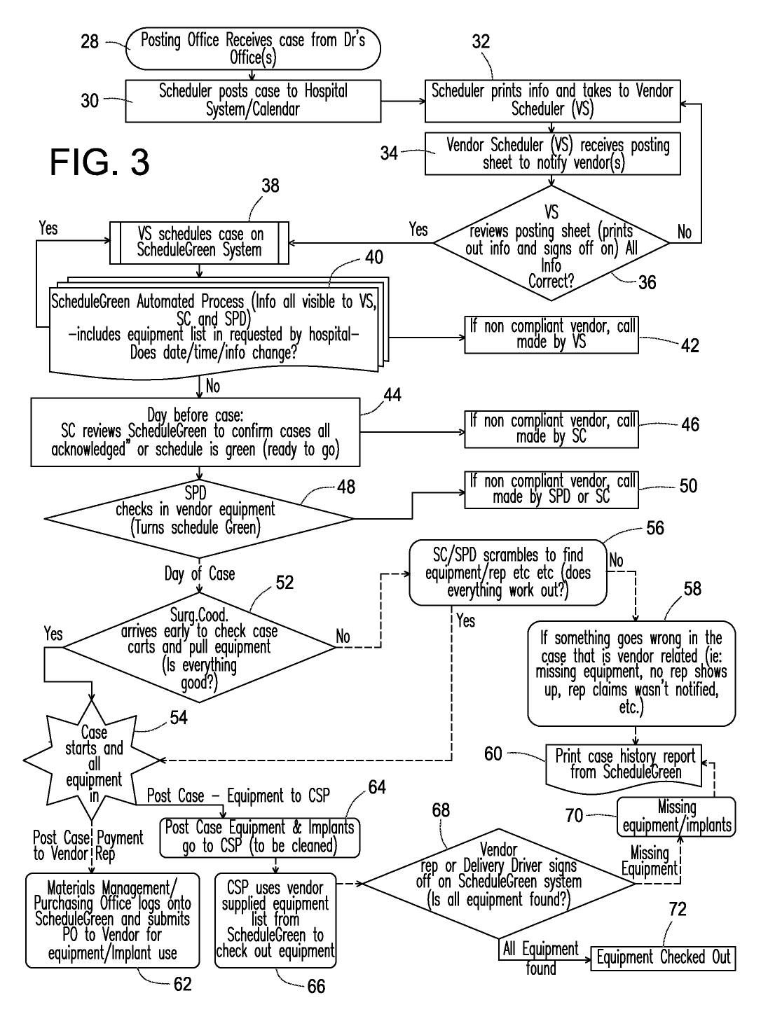

The healthcare facilities scheduling process for a surgical case according to the invention will be described with reference to FIG. 3. This flow diagram illustrates the steps for scheduling a case including the steps taken to assure notification from external vendors, steps to review specific vendor equipment submitted via the system to the healthcare facility, steps for the facility to take to check in equipment, steps taken by the facility to check equipment out of the facility after surgery is complete, steps taken for the facility to create a purchase order system to submit to a vendor representative, and steps taken to review the complete case history.

All of the scheduling is done through a color coordinated process that allows all associated parties to review the status of the appointment based on the display of colors, While any suitable color combination may be used, the following description will use the colors red, yellow, green, and black by way of example only.

At step 28, the healthcare facility posting office receives an appointment request containing specific case information from a doctor's office. The posting office works with the doctor's office staff to secure a specific operating room date and time slot for a procedure.

The hospital scheduler then posts the case utilizing their current system at step 30. The scheduler then prints information relating to the case appointment and delivers it to the staff member at step 32 who is responsible for organizing and submitting information to a vendor representative.

A facility staff member or vendor scheduler VS receives the posting sheet at 34 through the hospital's current scheduling method of choice and the vendor scheduler reviews the posting sheet and verifies its accuracy at step 36. If the sheet is not accurate, the scheduler reviews the information with the main facility scheduler who then reviews it with the doctor's office. If the information is accurate, the vendor scheduler posts the information to a web-based scheduling system.

At step 38, the vendor scheduler posts the case to the computer system 14 shown in FIG. 2. The system includes healthcare facility specific information including approved doctors, approved specialties, approved vendors companies, approved vendor specific products, approved vendor representatives and the like.

The automated system supplies a color coordinated scheduling process at step 40 that organizes a hospital operating room's three main departments, namely schedulers, operating room schedule coordinators SC, and sterile processing departments SPD along with case specific vendors and automatically streamlines the communication back and forth between all parties. If a response or information is missing, the healthcare facility staff member places a follow-up telephone call at step 42 to the entity who has not supplied a response or information.

On the day before the scheduled appointment, the operating room coordinators review the scheduling system at 44 to confirm that all vendor representatives are aware of the case and that the supplies necessary for the procedure are present. The system also provides the ability to print an equipment list for specific cases or all cases on a particular day to review the accuracy from the list supplied through the scheduling system from the vendor. If information is missing, the surgical coordinator telephones the vendor representative at 46 to confirm the case information

The sterile processing department checks to verify that the equipment required for the procedure is present at 48. If so, the system provides an indication by displaying a different color such as green to signal that everything is ready for the procedure. The case equipment list is provided by the vendor through the scheduling system. The sterile processing department reviews or prints out a list to verify the accuracy of the equipment. If equipment or information is missing, surgical coordinator or sterile processing department telephones the vendor.

On the day of the scheduled appointment, the surgical coordinator arrives early 52 to ensure that case carts are set for the day's cases using the equipment list supplied by the vendors to the scheduling system. At step 54, the scheduling system display is green and case starts with all necessary parties and equipment.

If equipment or a vendor representative is missing, surgical coordinators and sterile processing department personnel seek to find the missing equipment and representative at 56. If the case is delayed or cancelled 58, steps are taken to review why mistake happened.

A case history report can be printed by the schedule system at 60 to determine where the breakdown in communication happened. This list provides specific details on the entire scheduling process. Details include but are not limited to who scheduled the case and when, what was scheduled and when, when did the vendor approve or acknowledge the case, when did the sterile processing department turn the schedule green, when was a purchase order PO submitted and by who, and who picked up the equipment and when.

The system enables the management of the healthcare facility to submit a purchase order at 62 to a vendor or all vendors associated with a case.

Once the case is finished, the equipment is delivered to the sterile processing department at 64 to be reprocessed and cleaned. The sterile processing department uses the equipment list supplied by the vendor on the scheduling system to ensure that the right equipment is being checked out to the vendor or delivery driver at 66. The sterile processing department uses the supplied equipment list to confirm accurate removal of specific trays and equipment at 68.

If equipment is missing, information is logged onto the scheduling system and put into review via case history on the system at step 70. If all equipment checked out, a receipt is printed or signed out by the vendor or delivery driver.

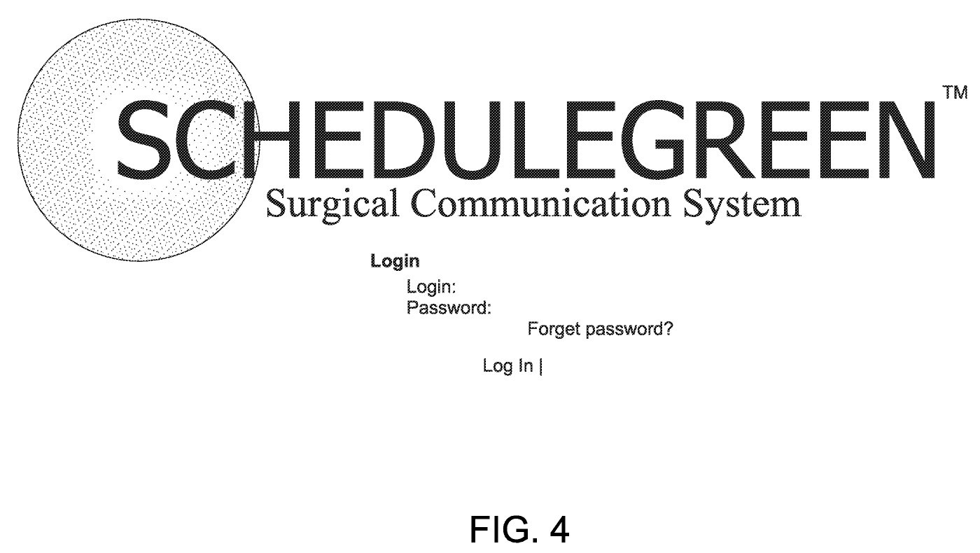

FIG. 4 illustrates the home page on the scheduling system 14 shown in FIG. 2. This is where the personnel from the healthcare facility and where vendors can log into the secure system.

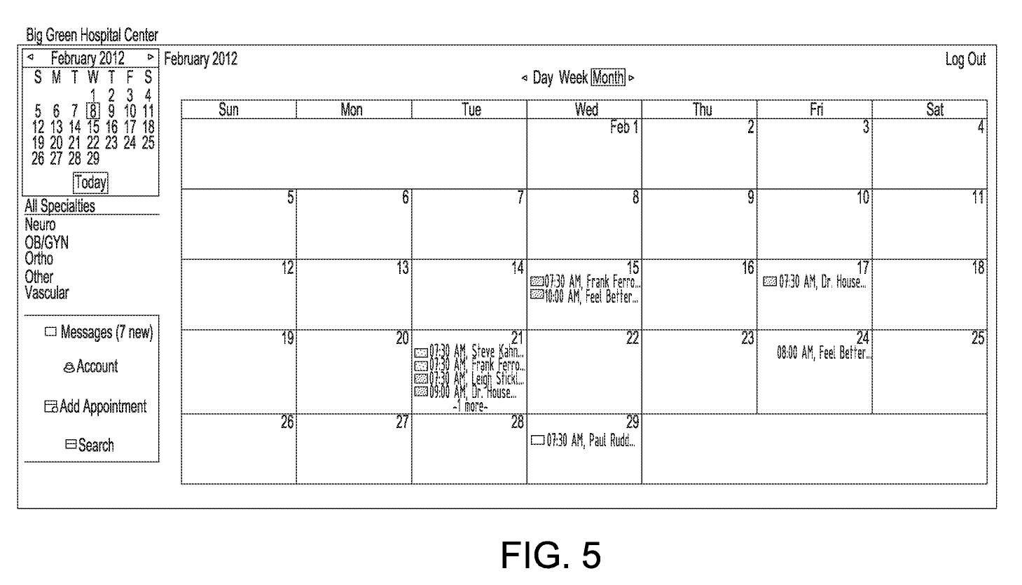

FIG. 5 shows a scheduling calendar for the system. The dates and times are color coded to provide a visual display of the status of the scheduling process. Using the color examples set forth above, red can designate a case scheduled by the facility or hospital, yellow designates vendor status and acknowledgement, green indicates that all equipment and accessories or implants for the procedure have been processed and are present and accounted for, and black indicates that the case has been cancelled. The calendar view can be broken down by specialty or procedure, i.e. orthopedic, neurological, vascular, and the like. The account tab is used for vendor credentialing, approved equipment, and approved doctors. The add appointment tab is used to add new appointments to the schedule and the search tab enables the schedule to be searched for specific case appointments.

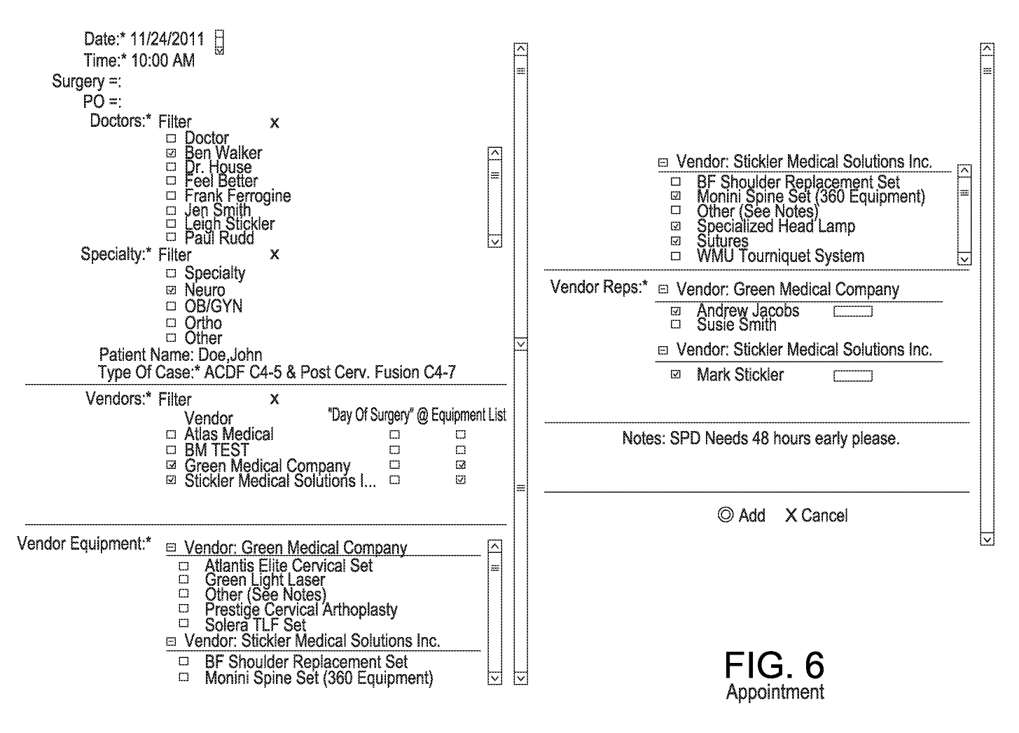

FIG. 6 shows the display for scheduling a case and indicating the equipment required, when it must be present for the procedure, and the vendors associated with the case.

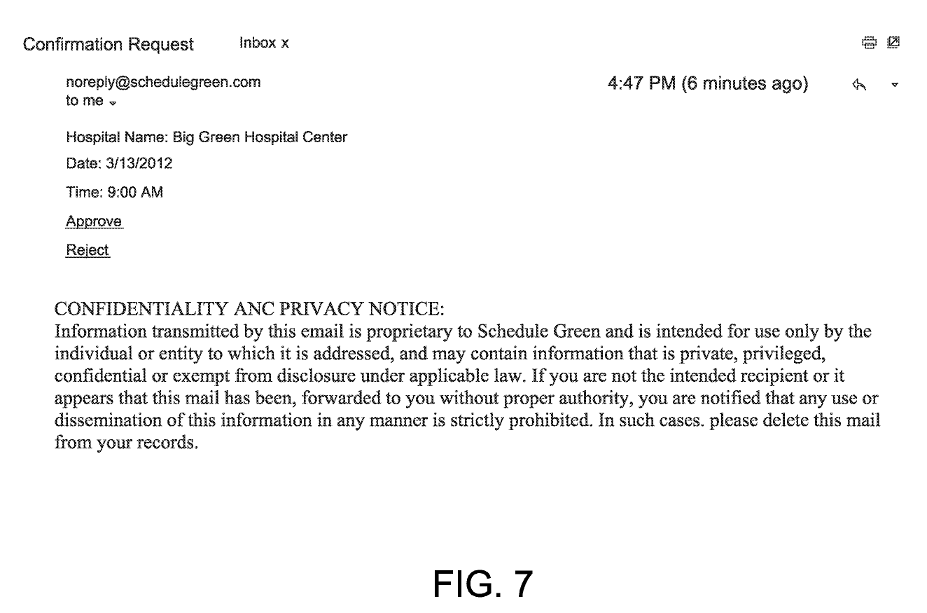

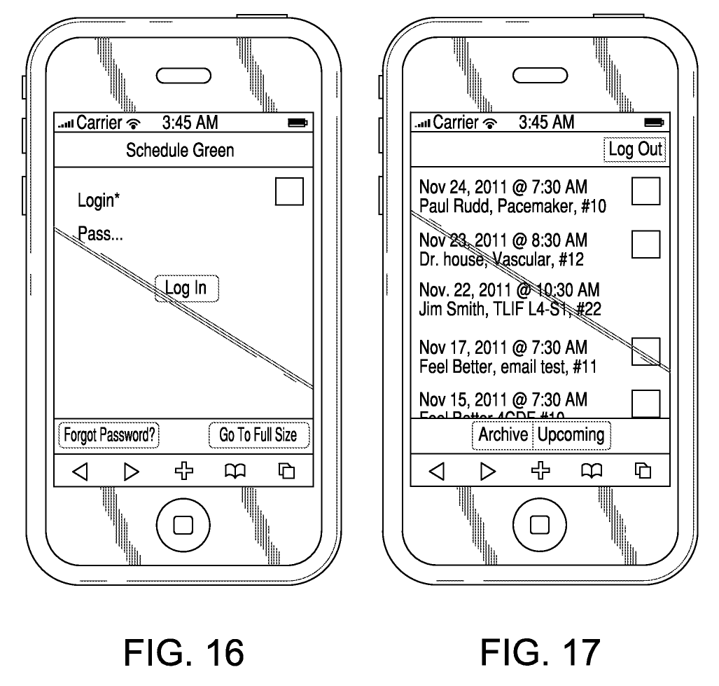

FIG. 7 is a sample vendor email. The vendor receives case notification containing basic scheduling information via email. The vendor must log in to the system to obtain specific details about the case. The vendor can create an equipment list to submit to the healthcare facility and approve a case to turn the vendor color to yellow signifying acknowledgement by the vendor. The vendor may also login via a mobile device as shown in FIGS. 16-23.

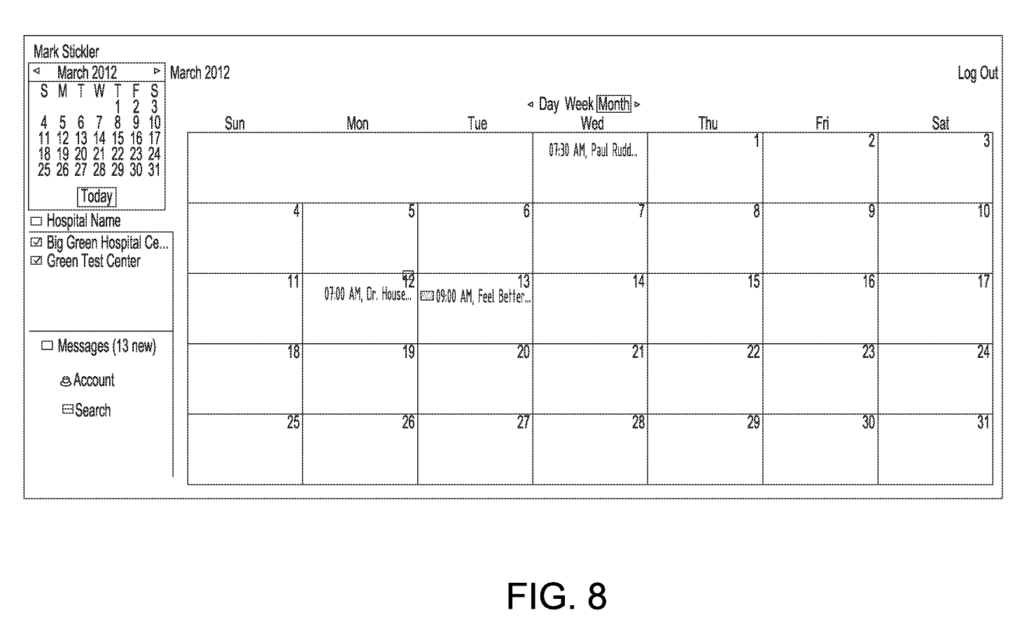

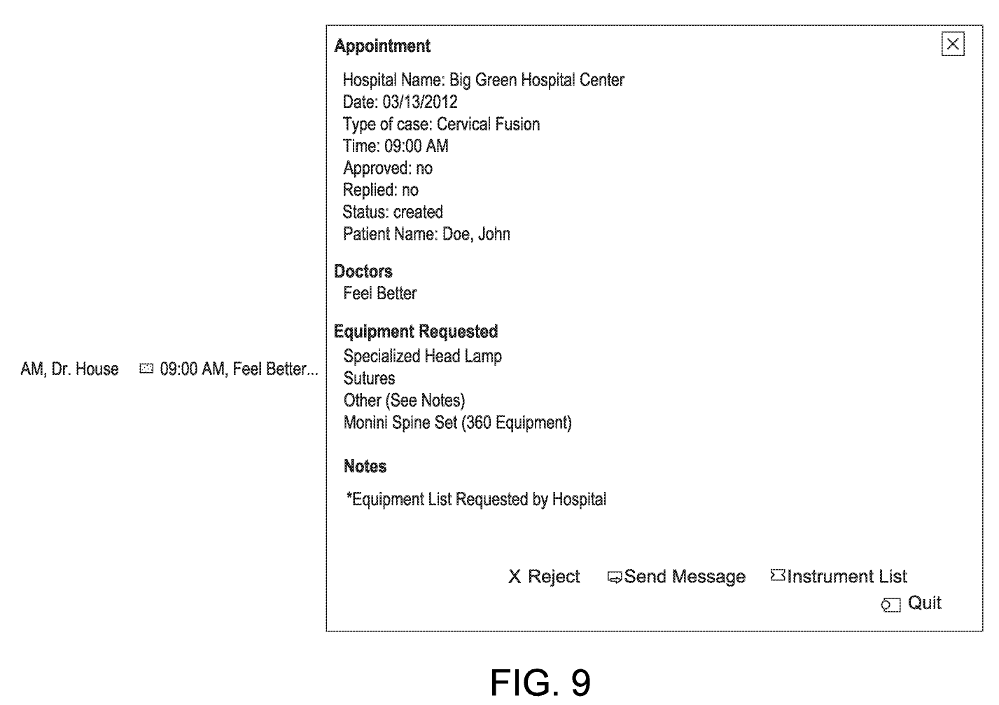

The vendor main page is shown in FIG. 8. The vendor can view their calendar by a specific hospital and manage their personal database via the account tab. This enables a vendor to manage its equipment, preset list, facilities, statements and the like. In FIG. 9, vendor approval of a case is represented. The vendor clicks on a case to pull up the case information. If the hospital selects “equipment list” from the scheduling tab, the vendor must supply the list befor being able to approve the case. The vendor then pulls up their instrument list and adds it to the system.

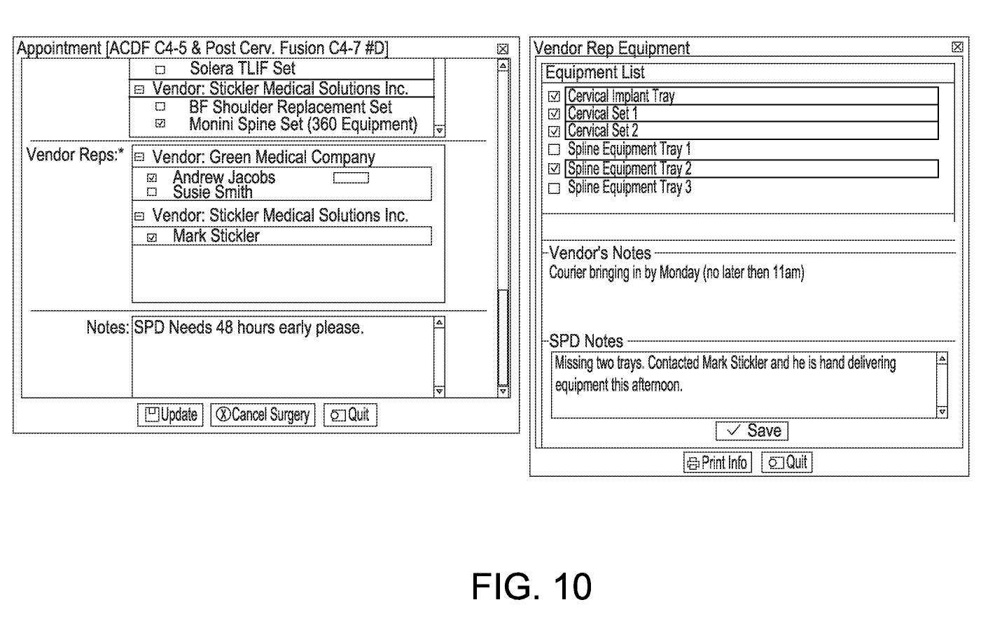

FIG. 10 shows the screen used by the sterile processing department. Once the equipment has been delivered to be cleaned and treated, the department can indicate its approval and completion, whereby the system provides a green indication that the facility is ready for the procedure.

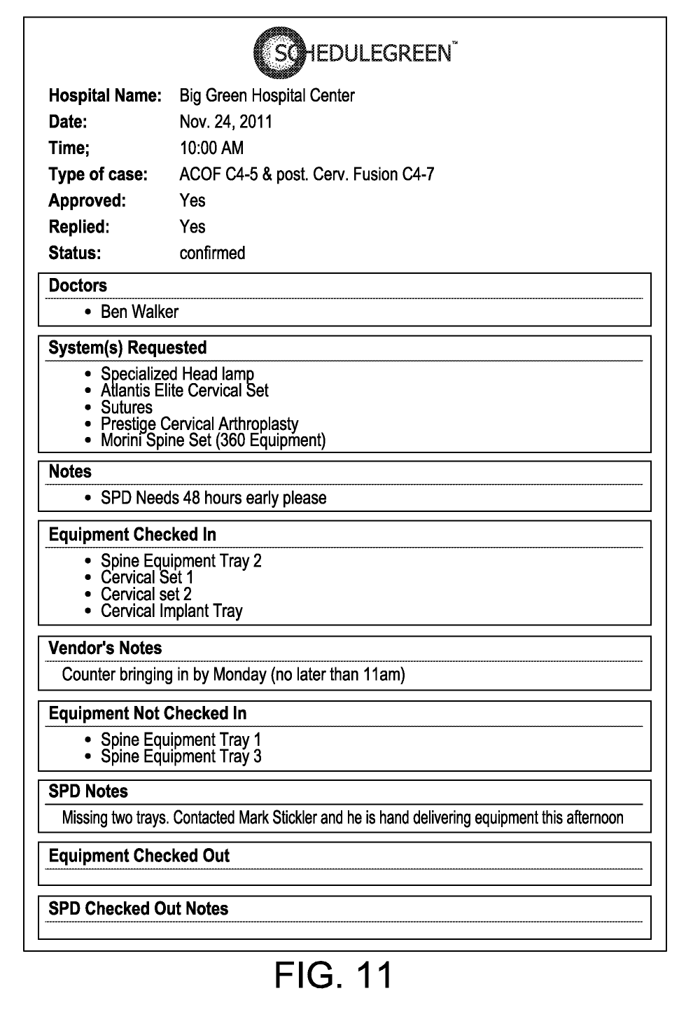

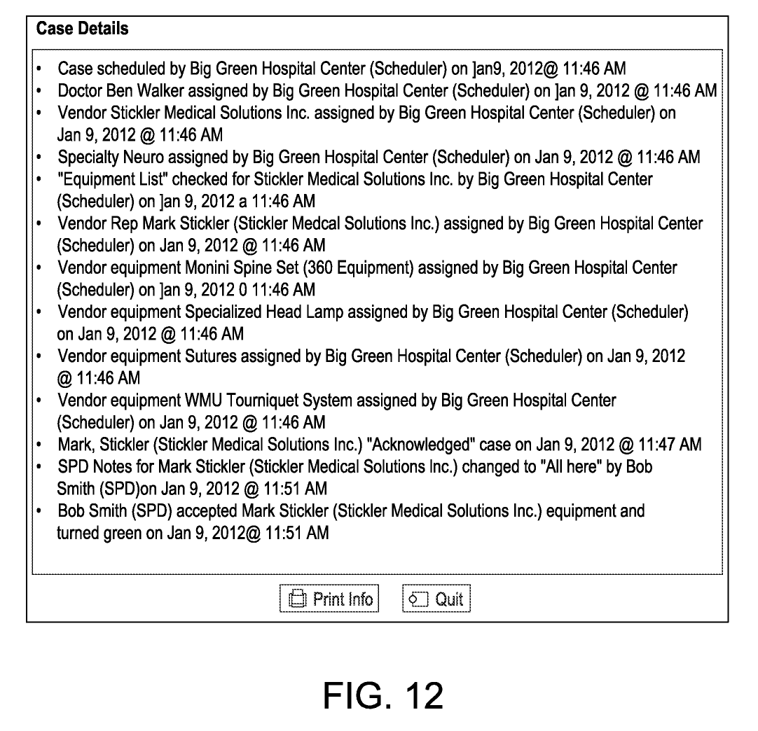

FIG. 11 is a sample print-out from the scheduling system. The information on the print-out is automatically pulled from the scheduling system based on information provided by the hospital scheduler, vendors, and sterile processing department. A history report for a case is shown in FIG. 12. It contains all relevant information regarding the case.

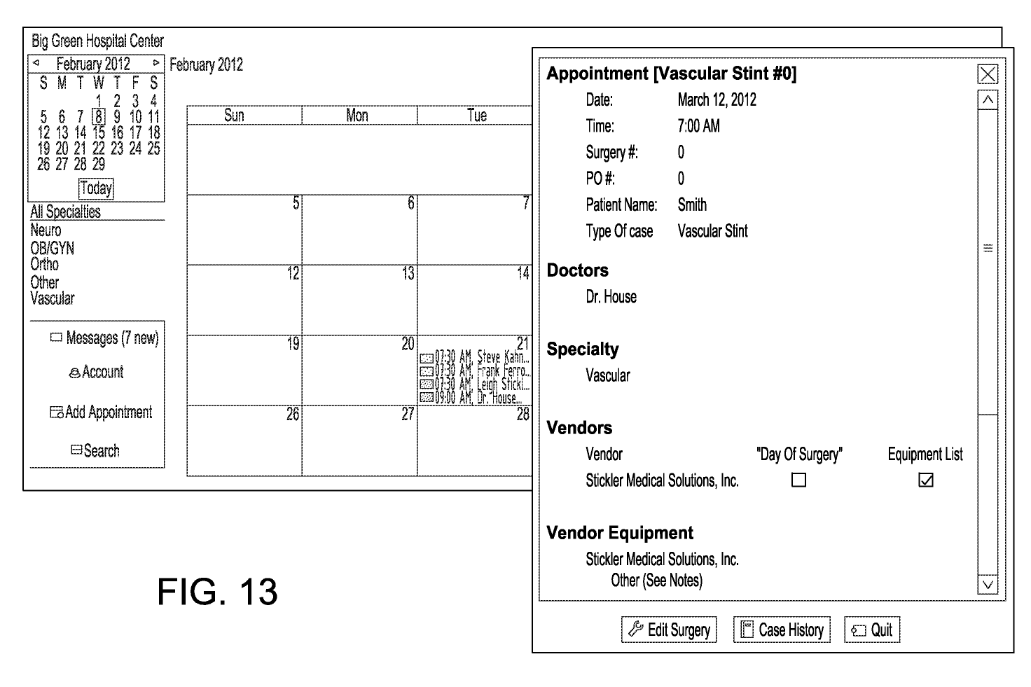

In order to change information for a case, the hospital scheduler may edit the information as shown in FIG. 13 to automatically update the information in the system. Vendors must approve the updated information.

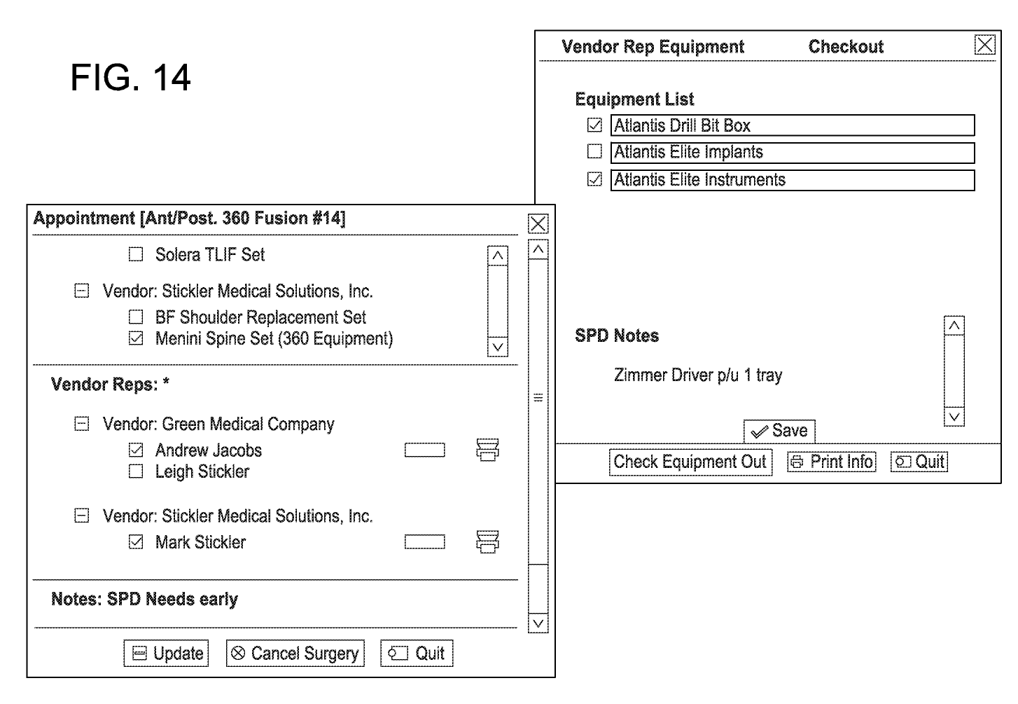

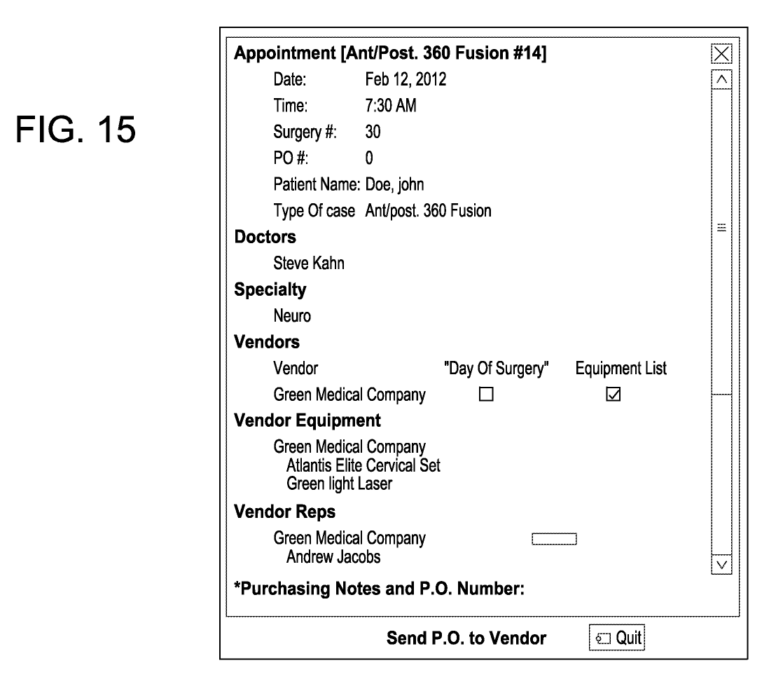

The system checkout page is shown in FIG. 14. This enables personnel to print out information regarding a case as well as to check out equipment for the procedure. A sample purchase order as described above is shown in FIG. 15.

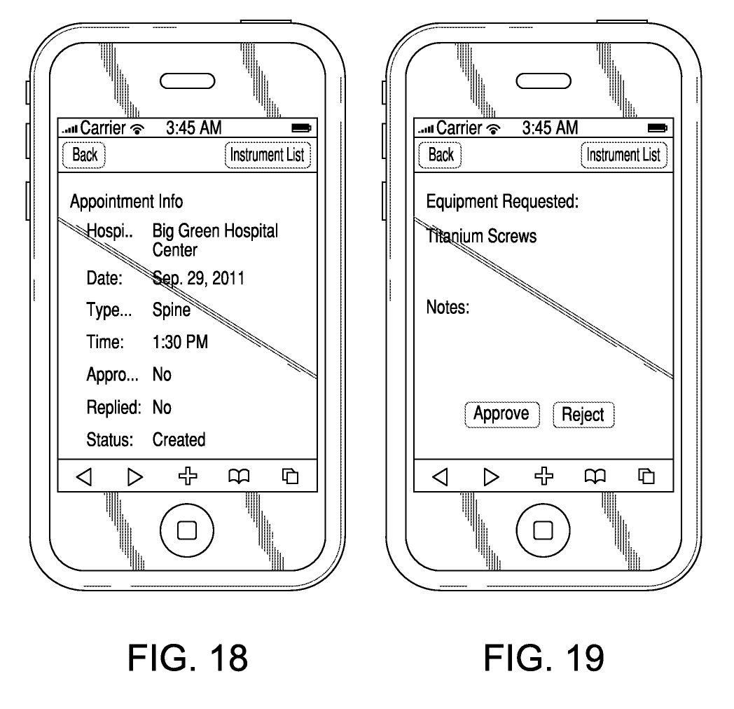

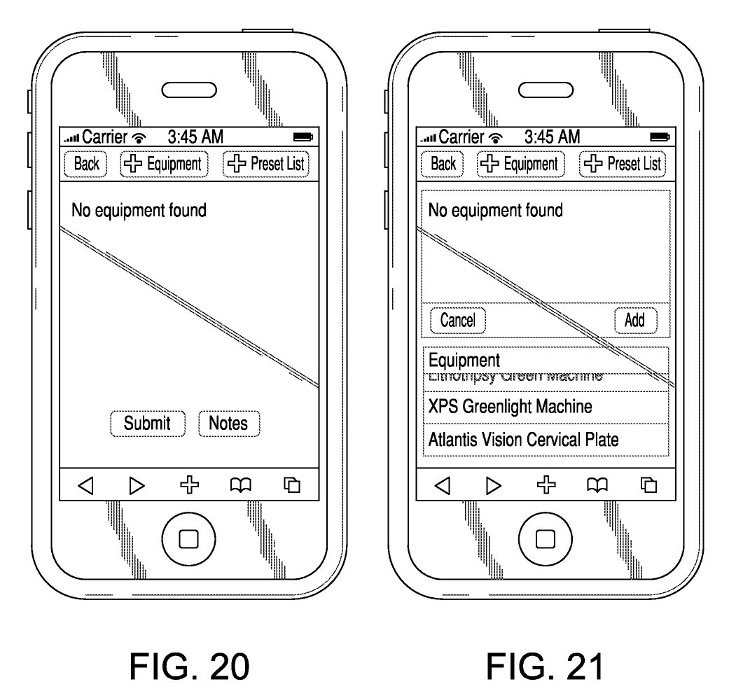

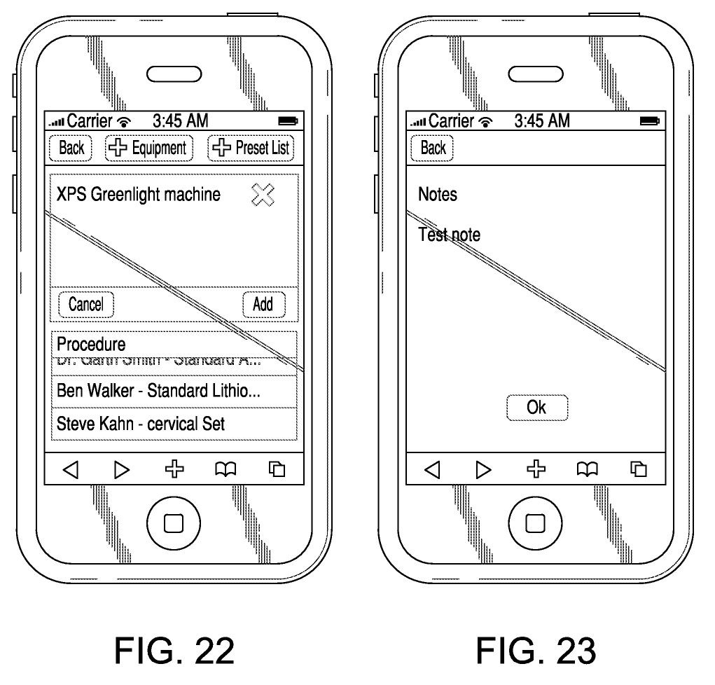

Turning now to FIGS. 16-23, there is shown a mobile device such as a smart phone which can be used to access the system shown in FIG. 2. In FIG. 16, the login page is displayed. Appointment details for the user of the device are shown in FIG. 17. FIG. 18 displays how appointments can be managed, and FIG. 19 provides for approval or rejection of appointments. In FIG. 20, the “Notes” is used to add notes to an instrument list. Customized or pre-loaded lists can be used as shown in FIG. 21. Equipment from a pre-loaded list is selected using the features shown in FIG. 22 and notes can be edited as shown in FIG. 23.

While the preferred forms and embodiments of the invention have been illustrated and described, it will be apparent to those of ordinary skill in the art that various changes and modifications may be made without deviating from the inventive concepts set forth above.

What is claimed is:

1. A method for scheduling a healthcare facility, comprising the steps of
(a) establishing a communication network between the healthcare facility, and at least one of a scheduling staff, a medical professional, a vendor, and a medical supply company;
(b) entering an appointment for the healthcare facility into a computer in response to a request from a medical professional;
(c) notifying at least one of the vendor and medical supply company of the appointment; and
(d) verifying that all parties participating in the appointment have acknowledged acceptance, whereby coordination of medical procedures in the healthcare facility is obtained with minimal errors and maximum efficiency.

2. A method as defined in claim 1, wherein said communication network is a secure network accessible only to authorized users.

3. A method as defined in claim 2, and further comprising the step of providing an indication when verification has been received from all parties participating in the appointment.

4. A method as defined in claim 3, wherein said indication is provided using different colors on a display device connected with the computer.

5. A method as defined in claim 4, wherein said color indications represent completion of successive steps in the process between the initial scheduling of the healthcare facility and completion of the appointment

6. A method as defined in claim 3, and further comprising the step of storing approved medical professionals, vendors and medical supply companies in the computer.

7. A method as defined in claim 6, and further comprising the step of preparing a case history report represent all of the steps of the scheduling process.

8. A method as defined in claim 3, wherein said communication network is a wireless network which is accessible by a mobile device.

9. A method as defined in claim 3, wherein said appointment includes information relating to at least one of the day and time of the appointment, the medical procedure being performed, the participants in the appointment, and the equipment required for the procedure.

10. A method as defined in claim 9, wherein said verifying step includes confirmation that the equipment required for the procedure is present in the healthcare facility.

11. A method as defined in claim 3, and further comprising the step of generating a purchase order to each vendor and medical supply company associated with each appointment.

12. A method as defined in claim 3, wherein said communication network further comprises a sterile processing department which sterilizes the healthcare facility prior to the appointment.
